(19) United States
(12) Patent Application Publication
(10) Pub. No.: US 2009/0141481 A1
(43) Pub. Date: Jun. 4, 2009

(54) Array light source using led and backlight unit including the same

(75) Inventors: Ho-Joon PARK, Seoul (KR); Jin-Cheol KIM, Hwaseong-si (KR); Sang-Jun YOON, Seoul (KR); Hwa-Young LEE, Suwon-si (KR); Geum-Hee YUN, Yongin-si (KR); Jun-Rok OH, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/081,949

(22) Filed: Apr. 23, 2008

(30) Foreign Application Priority Data
Nov. 29, 2007 (KR) 10-2007-0122831

(51) Int. Cl. G02F 1/13357; F21V 21/00; F21S 4/00

(52) U.S. Cl. 362/97.3; 315/185 R

(57) ABSTRACT

Disclosed are an array light source using a light-emitting diode and a backlight unit including the same. In accordance with an embodiment of the present invention, the array light source can include a plurality of light-emitting diodes (LED); and a wiring board on which wires for transferring signals to each of the LEDs are formed. Here, the wiring board can include a plurality of sublayers, and the wires can be divided into at least two wiring groups and separately formed on different sublayers of the wring board per wiring group.

### CROSS-REFERENCE TO RELATED PATENT APPLICATIONS

This application claims the benefit of Korean Patent Application No. 10-2007-0122831, filed on Nov. 29, 2007, in the Korean Intellectual Property Office, the disclosure of which is incorporated herein in its entirety by reference.

### BACKGROUND OF THE INVENTION

1. Field of the Invention

The present invention relates to a display apparatus, more specifically to an array light source using a light emitting diode and a backlight unit including the same.

2. Background Art

A cold cathode fluorescent lamp (CCFL) has been used as a light source for a backlight unit in a display apparatus such as a liquid crystal display. However, a mercury gas of the CCFL is used, which results in environmental pollution. Further, the CCFL has some issues such as slow response speed and low color reappearance and is not suitable to make the backlight unit thinner.

The environmentally friendly light-emitting diode (LED), however, has the high response speed of nanoseconds and is possible to perform impulsive driving. Further, the LED has good color reappearance, and the luminance and color temperature can befreely changed by adjusting the quantities of light of red, green and blue LEDs. As compared with the CCFL, the LED is suitable to make the backlight unit thin. Accordingly, today's trend shows that the LED is mainly employed for the light source of the backlight unit of the LCD.

However, in the case of the backlight unit and the light source using the LED, the method for making the backlight unit thin has been still requested in order to miniaturize and make thinner the LCD employing the backlight unit and to strength the competitiveness of products. In the conventional art, since all wires formed for the driving of the LED are arranged on the same plan (i.e. layer) of a wiring board, a limit has been placed on the miniaturized overall size of the light source and backlight unit manufactured by decreasing the size of the boar.

### SUMMARY OF THE INVENTION

The present invention provides an array light source and a backlight unit using a light-emitting diode that can become lighter, thinner and more miniature.

The present invention also provides an array light source and a backlight unit using a light-emitting diode that-can largely improve emitting magnitude and efficiency.

The present invention also provides an array light source and a backlight unit using a light-emitting diode that can enhance the flexibility of design when the light source and backlight unit are manufactured.

An aspect of the present invention features an array light source including a plurality of light-emitting diodes (LED); and a wiring board on which wires for transferring signals to each of the LEDs are formed. Here, the wiring board can include a plurality of sublayers, and the wires can be divided into at least two wiring groups and separately formed on different sublayers of the wring board per wiring group.

Here, the wires can be divided into a plurality of wiring groups according to colors of beams of light emitted from the LED.

The wiring group formed in the wiring board can be electrically connected to the LED mounted on a surface of the wiring board through a via hole.

The thermoplastic resin can be one of polyetherimide (PEI), polyethersulfone (PES), polyetheretherketone (PEEK) and polytetrafluoroethylene (PTFE) and liquid crystal polymers or a combination thereof.

The thermoplastic resin board can be made of a thermoplastic resin including a glass cloth.

The wiring board can be manufactured to have a bar shape. Here, the plurality of LEDs can be arranged in a line in the wiring board.

Another aspect of the present invention features a backlight unit, which is manufactured to perform light emission by allowing a plurality of array light sources using the forgoing light-emitting diode to be adjacently arranged.

### BRIEF DESCRIPTION OF THE DRAWINGS

These and other features, aspects and advantages of the present invention will become better understood with regard to the following description, appended claims and accompanying drawings where:

FIG. 1 is an exploded perspective view showing an example of a bar-shaped array light source using a light-emitting diode;

FIG. 2 is a literal sectional view showing the array light source of FIG. 2;

FIG. 3 is an example of a different wiring type from the wiring type employed for an array light source using a light-emitting diode in accordance with an embodiment of the present invention;

FIG. 4 shows an array light source using a light-emitting diode and a wiring type of an array light source in accordance with an embodiment of the present invention; and

FIG. 5 is an example of a backlight unit manufactured by using an array light source in accordance with an embodiment of the present invention.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

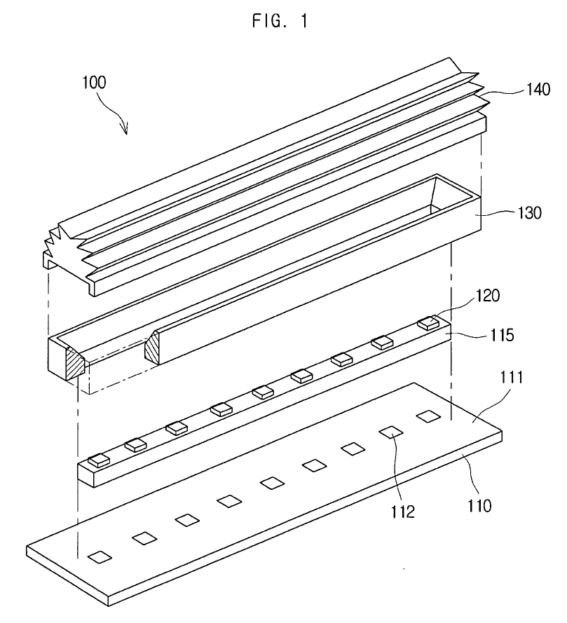

Prior to describing the present invention in detail, an array light source using a light-emitting diode related to the present invention will be described with reference to FIG. 1 through FIG. 3.

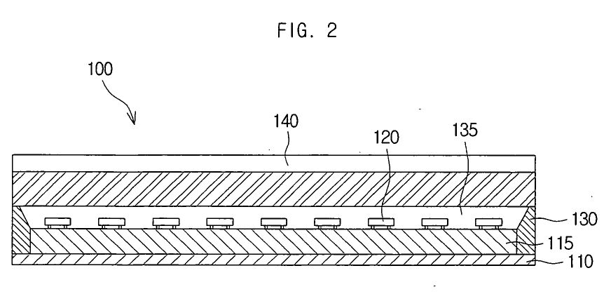

FIG. 1 is an exploded perspective view showing an example of a bar-shaped array light source using a light-emitting diode, and FIG. 2 is a literal sectional view showing the array light source of FIG. 2.

Referring to FIG. 1 and FIG. 2, the array light source 100 includes a wiring board 110, a plurality of light-emitting diodes (LED) 120, a reflection part 130, a molded part 135 and a lens 140.

The wiring board 110 is manufactured to have a bar shape that stretches in a direction. A surface 111 of the wiring board 110 is formed with a plurality of pads 112 corresponding to each point on which the LEDs 120 are mounted and wires (not shown) for transferring an electric signal necessary for the driving of the LED 120.

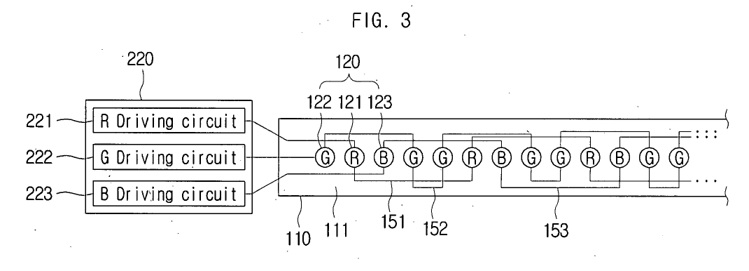

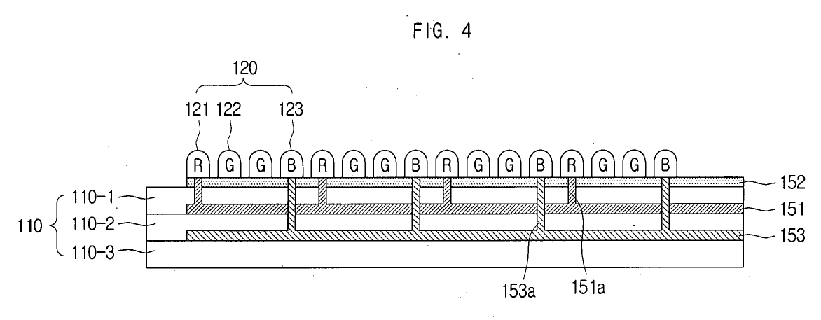

Here, the wire, which is a predetermined circuit pattern formed by a conductive material in order to be electrically connected to the LED 120, is actually formed in a surface (i.e. the surface 111 in FIG. 1) of the wiring board 110. However, the illustration of the wire pattern formed on the surface 111 of the wiring board 110 has been omitted for the convenience of illustrating. This can be clearly understood through the below description related to FIG. 3 and FIG. 4.

The plurality of LEDs 120 is arranged in a line by being away from each other. The LED 120 can be directly seated in the pad 112 formed on the surface 111 of the wiring board 110. Also, as shown in FIG. 1 and FIG. 2, the LED 120 can be seated in the pad 112 by allowing a kind of medium (e.g. a base 115) to be interposed in between. If a material having high thermal conductivity or heat-radiation is used as the base 115, the heat generated by the driving of the LED 120 can be easily emitted to an outside. In this case, the base 115 can serve as a kind of heat sink. Here, even though it is natural that the LED 120 is mounted on the wiring board 110 by a wire bonding or a flip-chip bonding, since this pertains to one of well-known technologies, the pertinent detailed description will be omitted.

The reflection part 130, which is placed along the border of the wiring board 110, allows beams of light of all directions emitted from the LED 120 to proceed toward an upper side. Herein, the reflection part 130 is manufactured to include slopes having a predetermined angle with respect to the surface on which the LED 120 and to have a shape capable of enveloping all LEDs 120. A material having light reflection can be coated on each slope of the reflection part 130. Alternatively, a reflection plate can be settled on each slope of the reflection part 130. Accordingly, the predetermined angle of the slopes determines the angle at which the beams of light emitted from the LED 120 proceed toward the upper side.

The molded part 135 protects the LED 120 and settles a bonding means used for the mounting of the LED 120 such that the bonding means can maintain its original shape as it is. The molded part 135 is typically molded by using a molding resin such as an epoxy molding compound. Also, if the molded part 135 is molded by using a compound resin of the molding resin and a fluorescent material, the molded part 135 serves to improve the radiation property and radiation efficiency.

The lens 150, which is placed at an upper part of the reflection part 130 and the molded part 135, refracts a beam of light emitted from the LED 120 to an outside. At this time, it is natural that the lens 150 has any shape capable of refracting a beam of light incident from a lower part in a direction as well as that of FIG. 1.

FIG. 3 is an example of a different wiring type from the wiring type employed for an array light source using a light-emitting diode in accordance with an embodiment of the present invention. In other words, FIG. 3 shows the conventional wiring type.

As shown in FIG. 3, a plurality of red LEDs 121, green LEDs 122 and blue LEDs 123 can be arranged in a line on the surface 111 of the bar-shaped wiring board 110. At this time, the same-color LEDs is electrically arranged in series, and the different-color LEDs is electrically arranged in parallel. In particular, the red color LEDs 121 is mutually connected to a red driving circuit 221 of a driving unit 220 in series through a red LED wire 151, and the green color LEDs 122 is mutually connected to a green driving circuit 222 of a driving unit 220 through a green LED wire 152. The blue color LEDs 123 is mutually connected to a blue driving circuit 223 of a driving unit 220 through a blue LED wire 153. Also, since each one port of the red driving circuit 221, the green driving circuit 222 and the blue driving circuit 223 is processed as a common ground, the different-color LEDs can be mutually connected in parallel.

The forgoing wiring principle (i.e. the same-color LEDs are mutually connected in series, and the different-color LEDs are mutually connected in parallel) is applied to the present invention. Below is described some disadvantages of the conventional wiring type as compared with the wiring type of the present invention.

A limit has been placed on the miniaturized side of the wiring board 110 because the conventional wiring type allows all wires to be arranged and formed on a surface (i.e. one same plane) of the wiring board 110. This is because the minimum specifications (e.g. the minimum line width, which is required to protect the wire from being shorted out, and the minimum spacing, which is required to protect the adjacent wires having different signals from being in contact with each other) complying with the layout design rule is required to be maintained.

Accordingly, a limit has been placed on the number of wires capable of being arranged on the same board area. The increased number of the wires required to be arranged on the board has resulted in the enlarged necessary board area.

The conventional art has used a board made of a ceramic material having good hardness as the wiring board 110. While the ceramic board has good hardness, it is difficult to reduce the width of wire and the thickness of board.

Accordingly, the light source, the backlight unit and the LCD having the same, manufactured by the conventional wiring type by which all necessary wiring patterns are arranged and formed and by using the conventional board material such as the ceramic material, has been inappropriate for the today's trend toward compact and thin products.

Thus, the wiring type of the present invention will be described hereinafter to solve the aforementioned problems.

FIG. 4 shows an array light source using a light-emitting diode and a wiring type of an array light source in accordance with an embodiment of the present invention.

As shown in FIG. 4, the array light source in accordance with an embodiment of the present invention can include-a plurality of light-emitting diodes (LED) 120 and a wiring board 110 on which the LEDs 120 are mounted and wires 151, 152 and 153 for transferring signals to each of the LEDs 120 are formed. At this time, the wiring board 110 can be manufactured to have a bar shape as shown in FIG. 1, and the plurality of LEDs 120 can be arranged in a line along the lengthwise direction of the bar-shaped wiring board 110.

In the present invention, the wiring board 110 can be manufactured to have a plurality of sub-layers. For example, the wiring board 110, as shown in FIG. 4, can be manufactured to have a first sub-layer 110-1, a second sub layer 110-2 and a third sub-layer 110-3. The reason that the wiring board 110 is manufactured to have the plurality of sub-layers may be to separately arrange the wires, electrically connected to the LED 120 and transfers signals to the LED 120, on different planes (i.e. different sub-layers) of the wiring board 110.

Accordingly, all wires required to be arranged for the driving of the LED 120 can be divided into a plurality of wiring groups. The wires can be separately arranged on different sub-layers of the wiring board 110 per divided wiring group. Below is described the standard and the method for being applied to the separate arrangement of wires per wiring group.

For example, in case that the plurality of LEDs 120 are formed to include at least one red LED 121, at least one green LED 122 and at least one blue LED 123, the wires can be divided into 3 wiring groups according to the colors of beams of light emitted from the LED 120 and can be separately arranged on different sub-layers. For example, a green LED wire 152, which is a first wiring group, can be separately arranged on the first sub-layer 110-1. A red LED wire 151, which is a second wiring group, can be separately arranged on the second sub-layer 110-2. A blue LED wire 153, which is a third wiring group, can be separately arranged on the third sub-layer 110-3.

In this case, the wiring group (e.g. the red LED wire 151 and the blue LED wire 153 in the case of FIG. 4), which is arranged in the wiring board 110, of the wiring groups can be electrically connected to the LEDs 120 mounted on the surface of the wiring board 110 through each via hole 151a and 153a.

Of course, the method for dividing into the wiring groups can be based on other dividing standards as well as the foregoing color dividing standard. For example, the wires can be equally divided according to the total number of wires. Also, in case that the wires is divided into the wiring groups according to the color dividing standard and one wiring group is further divided into at least two wiring subgroups per same color, the subgroups can be separately on different sublayers. Alternatively, the color dividing standard and the wiring number dividing standard can be used together.

For example, if the radio of the numbers of the green LED, the red LED and the blue LED, which are equipped according to the Bayer pattern, is 2:1:1, the green LED wire can pertain to a wiring group, and the red and blue LED wires can pertain to another wiring group. Accordingly, the green LED wire and the red and blue LED wires can be separately arranged on two different sublayers. Of course, it shall be evident that even though the red and blue LED wires are classified as one wiring group, the red and blue LED wires can be required to be in no contact with each other on the same sublayer.

As such, using the wiring dividing method of the present invention makes it possible to reduce the size of the wiring board 110 as compared with the conventional wiring dividing method by which all wires are arranged on the same plane of the wire board 110. This can help the array light source, the backlight unit and the LCD having the same to be miniaturized. As a result, this can be applied to compact portable display apparatuses (e.g. mobile phones, PMP and UMPC) as well as large-sized display apparatus.

Also, since using the wiring dividing method of the present invention can result in more element arranging space as compared with the conventional art, more LEDs can be mounted on the same space, to thereby the emitting magnitude and efficiency largely.

However, the wire dividing method may need the wiring board 110 including a plurality of sublayers, which causes the thickness of board to be increased. This may be inappropriate for the today's trend toward making thinner. Accordingly, in accordance with an embodiment of the present invention, the thermoplastic resin based wiring board 110 can be used.

For example, the thermoplastic resin based wiring board 110 can be made of one of high-functional engineering plastics such as polyetherimide (PEI), polyethersulfone (PES), polyetheretherketone (PEEK) and polytetrafluoroethylene (PTFE) and liquid crystal polymers having high heat-resistance and hardness or a combination thereof. Further, it is natural that a glass cloth can be added into the foregoing thermoplastic resin to improve the physical hardness and elasticity, or some ceramic filler having high thermal conductivity can be added to improve the heat-emission.

As compacted with the usually used ceramic material based board as the conventional wiring board, the aforementioned thermoplastic resin based wiring board makes it possible to be manufactured to be thin enough to have no influence on the thickness all units (i.e. the array light source, the backlight unit and the LCD having the same) in spite of being formed as a multilayer.

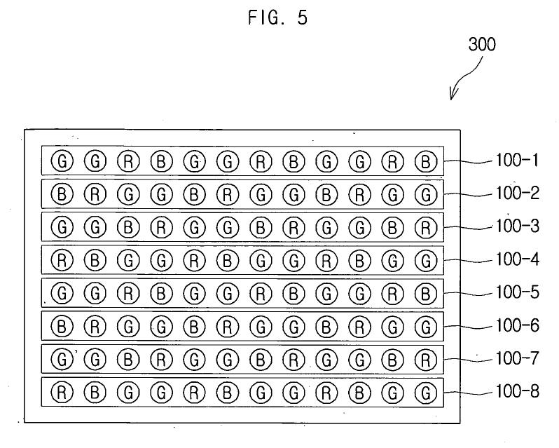

Even through the above description is related to an array light source using a light-emitting diode that is manufactured by using a wire dividing method in accordance with an embodiment of the present invention, as another embodiment of the present invention, the array light source of FIG. 4, for example, can be manufactured as one backlight unit 300 (refer to FIG. 5) by allowing a plurality of array light sources to be adjacently arranged (refer to 100-1 through 100-8 of FIG. 5).

In other words, the backlight unit can be typically classified into an edge type backlight unit, which is placed in a long bar type to emit a beam of light on a overall surface of a liquid crystal panel, and a rare type backlight unit, which is placed below the liquid crystal panel to emit a beam of light as a surface light source having a nearly identical size to the liquid crystal panel (refer to FIG. 5), according to the position of the light source. The array light source in accordance with an embodiment of the present invention can be applied to any backlight unit without restriction to the edge type backlight unit or the rare type backlight unit.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. An array light source, comprising:
a plurality of light-emitting diodes (LED); and
a wiring board on which wires for transferring signals to each of the LEDs are formed,
wherein the wiring board includes a plurality of sublayers, and the wires are divided into at least two wiring groups and are separately formed on different sublayers of the wring board per wiring group.

2. The array light source of claim 1, wherein the wires are divided into a plurality of wiring groups according to colors of beams of light emitted from the LED.

3. The array light source of claim 1, wherein the wiring group formed in the wiring board is electrically connected to the LED mounted on a surface of the wiring board through a via hole.

4. The array light source of claim 1, wherein the wiring board is a thermoplastic resin board.

5. The array light source of claim 4, wherein the thermoplastic resin is one of polyetherimide (PEI), polyethersulfone (PES), polyetheretherketone (PEEK) and polytetrafluoroethylene (PTFE) and liquid crystal polymers or a combination thereof.

6. The array light source of claim 4, wherein the thermoplastic resin board is made of a thermoplastic resin including a glass cloth.

7. The array light source of claim 1, wherein the wiring board is manufactured to have a bar shape, whereas the plurality of LEDs are arranged in a line in the wiring board.

8. A backlight unit, which is manufactured to perform light emission by allowing a plurality of array light sources to be adjacently arranged,
the array light source comprising:
a plurality of light-emitting diodes (LED); and
a wiring board on which wires for transferring signals to each of the LEDs are formed,
wherein the wiring board includes a plurality of sublayers, and the wires are divided into at least two wiring groups and are separately formed on different sublayers of the wring board per wiring group.
